(19) United States
(12) Patent Application Publication
(10) Pub. No.: US 2012/0204674 A1
(43) Pub. Date: Aug. 16, 2012

(54) HARMONIC MOTOR, DRIVE ASSEMBLY, INDUSTRIAL ROBOT, ROBOT BOOM AND ROBOT JOINT

(76) Inventors: Ivan Lundberg, Vasteras (SE); Jan Larsson, Vasteras (SE); Daniel Sirkett, Vasteras (SE); Sönke Kock, Schriesheim (DE)

(21) Appl. No.: 13/410,742

(22) Filed: Mar. 2, 2012

Related U.S. Application Data
(63) Continuation of application No. PCT/EP2008/066743, filed on Dec. 4, 2008.
Application No. PCT/EP2008/066743 is a continuation of application No. PCT/EP2009/061702, filed on Sep. 9, 2009.
(60) Provisional application No. 60/996,795, filed on Dec. 5, 2007.

(51) Int. Cl. F16H 49/00

(52) U.S. Cl. 74/640

(57) ABSTRACT

A harmonic motor with a circular and internally geared stator, a flex spline coaxially arranged within the stator which comprises both external and internal gears, and a geared output shaft coaxially arranged within the flex spline. A drive assembly that includes a motor with a motor housing, a rotor, a rotor shaft, and a rear bearing for supporting the rotor shaft in the motor housing at a rear side of the rotor; and a strain wave gearing including a circular spline secured to the motor housing, a flex spline engaging the circular spline, a wave generator engaging the flex spline and secured to a drive end of the rotor shaft, and a wave generator bearing between the circular spline and the wave generator. The wave generator bearing serves as an exclusive drive end bearing for supporting the rotor shaft in the motor housing at a front side of the rotor.

### CROSS-REFERENCE TO RELATED APPLICATIONS

The present application is a continuation of pending International Patent Application PCT/EP2008/066743 filed on Dec. 4, 2008 which designates the United States and claims priority from U.S. Patent Application 60/996,795 filed on Dec. 5, 2007, and is a continuation of pending International Patent Application PCT/EP2009/061702 filed on Sep. 9, 2009 which designates the United States, the content of all of which is incorporated herein by reference.

### FIELD OF THE INVENTION

The present invention relates to motors that provide rotary motion. A motor comprising a harmonic gear reducer with an integrated, active means for generation of the traveling wave is referred to as a harmonic motor.

This invention relates to a drive assembly comprising a motor including a motor housing, a rotor, a rotor shaft, and a rear bearing for supporting the rotor shaft in the motor housing at a rear side of the rotor; and a strain wave gearing including a circular spline secured to the motor housing, a flex spline engaging the circular spline, a wave generator engaging the flex spline and secured to a drive end of the rotor shaft, and a wave generator bearing between the circular spline and the wave generator. The invention also relates to an industrial robot, a robot boom and a robot joint provided with such a drive assembly.

### BACKGROUND OF THE INVENTION

Electric motors are commonly used as prime motive power for many industrial applications. However, their high speed, low torque characteristics are not ideal for robotics axes in which high torque, low speed characteristics are desirable. This necessitates the use of high reduction gearing. For robotics applications a typical drive solution is to use an electric motor in conjunction with a harmonic drive gear reducer. Through suitable mounting arrangements, it is possible to achieve partial integration of the motor and gear reducer.

A harmonic drive is a gear reduction device that exploits material flexibility in order to achieve a high reduction ratio with minimal backlash. In comparison to conventional multi-stage spur gear trains of similar reduction ratios, the harmonic drive offers a more compact and lightweight drive of simpler construction which lends itself well to high precision applications such as robotics.

The operating principle of the harmonic drive gear reducer is shown in FIGS. 6a-6f. The three main components in a typical harmonic drive are a flex spline, a circular spline and a wave generator. The input, output and fixed components are interchangeable amongst these components, but in the embodiment shown in FIGS. 6a-6f, the input is the wave generator, the output is the flex spline and the circular spline remains stationary. The flex spline 1 consists of a flexible tube that is closed at one end and upon whose outer surface are cut gear teeth. The wave generator is an elliptical cam 2 around whose periphery is placed a bearing 3. The wave generator locates inside the flex spline, such that the flex spline deforms elastically into an elliptical shape. The flex spline locates inside the circular spline 4, which is a rigid gear having internal teeth. There are 2n (where n is a positive integer) fewer teeth on the flex spline than on the circular spline. The teeth of the flex spline mesh with those of the circular points at the two lobes at either end of the major axis of the ellipse. Rotary input is applied to the wave generator cam, causing the deformed elliptical shape of the flex spline to rotate. In this manner a “traveling wave” is set up in the flex spline. Due to the disparity in the number of teeth between the two gears, rotation of the flex spline ellipse shape causes the flex spline itself to rotate in the opposite sense to the cam and at a reduced speed. The reduction ratio achievable using this drive is given by the number of teeth on the flex spline divided by 2n.

US2005253675 teaches a harmonic motor driven using electromagnetic principles, as first suggested in the original CW Musser's original patent U.S. Pat. No. 2,906,143 (FIGS. 9a-9b). The circular flexspline 1 is sandwiched between a stationary circular core 2 and a stationary stator 3. Around the inward facing surface of the stator and the outward facing surface of the core are arranged solenoids 4 wound around radial-aligned teeth. By driving a pair of coils diametrically opposite one another on the core and a second pair of coils 90 degrees offset from these and diametrically opposite one another on the stator, the flex spline is attracted to the core at two regions which represent the extreme of its minor axis, and to the stator at the extreme of its major axis. By sequentially energizing adjacent sets solenoids, the regions of attraction are made to rotate, thereby producing the traveling wave. The flex spline is equipped with inward-facing teeth which mesh with a circular output spline 5 that is located within the flex spline.

JP19900230014 teaches a similar arrangement comprising electrostatic means of actuation. The main advantage of drives operating on electrostatic or electromagnetic actuation principles is that the only moving part is the output shaft itself. Hence stored kinetic energy is greatly reduced.

U.S. Pat. No. 6,664,711B2 teaches a harmonic motor using an electromagnetic principle and additionally equips the flex spline with magnets 1 opposite the solenoid cores 2 and exploits repulsion effects instead of attraction (FIG. 10).

U.S. Pat. No. 7,086,309B2 teaches an arrangement wherein pneumatic actuators are mounted externally to the flex spline to drive a conventional elliptical wave-generator cam. The document also teaches an arrangement with radial acting pneumatic diaphragm actuators mounted within the flex spline cylindrical void and acting directly on its surface to generate the rotating elliptical shape. The arrangement is as shown in FIG. 8 and the actuators are capable of both pushing and pulling the flex spline surface and the elliptical shape is fully constrained at all times, but losses arise due to viscoelastic effects.

Thus, there is a need to reduce the manufacturing costs and the weight as well as simplifying the control of a harmonic motor. The prior art motors do not fulfill this need.

When mounting a motor and a wave generator in a harmonic/strain wave drive it is important that the motor and wave generator axes are accurately aligned with the circular spline axis of the harmonic drive.

The concentricity demand for these parts is typically in the range of 10-20 μm and is very hard to meet in practice, since it requires strict tolerances on both the motor and the mounting surface for the motor.

If the wave generator concentricity is not met, the friction of the harmonic drive increases and the running becomes unsmooth, typically with two friction peaks per motor revolution, when the elliptic lobes of the wave generator align with the eccentricity.

To overcome this problem, harmonic drive gearboxes can be fitted with an Oldham coupling between the motor shaft and the wave generator. Using the Oldham coupling roughly doubles the allowed eccentricity and makes it possible to meet the tolerance requirements with “standard” machining operations.

There are some drawbacks associated with using Oldham couplings, e.g. slightly increased backlash, cost and weight. Also, Oldham couplings are not available for the smallest harmonic drive gearboxes (size 3 & 5).

### SUMMARY OF THE INVENTION

The aim of the invention is to remedy the above mentioned drawbacks with harmonic motors defined, as mentioned above.

The above problem is according to the first aspect of the invention solved in that a device of the kind in question has the specific features that it comprises a fixed circular and internally geared stator, a flex spline coaxially arranged within the stator where the flex spline comprises both external and internal gears. Further, a geared output shaft is coaxially arranged within the flex spline and the motor further comprises means for sequentially deforming the flex spline into an ellipse shape, internally meshing the output shaft. Further, the number of teeth on the stator equals the external teeth on the flex spline such that the flex spline meshes at two lobes of the ellipse shape and every tooth on the flex spline meshes with the same counterpart tooth on the stator.

The flex spline is stationary and this arrangement prevents rotation of the flex spline relative to the circular stator and the rotary output is taken from the central circular gear. The external flex spline arrangement increases the torque per unit diametric deformation of the flex spline, which improves efficiency.

According to a feature of the invention, the means for deforming the flex spline comprises a plurality of actuators internally arranged in the stator means adapted to deform the flex spline directly into the desired shape. Compared with actuation from within the flex spline, external actuation increases the space available for mounting the actuators and is claimed to increase the efficiency of the drive.

According to a feature of the invention, the actuator is a discrete and linear actuator adapted to transfer forces from the actuator acting directly on the flex spline. The plurality of actuators is driven in a predefined sequence to produce a traveling wave. The actuators share a common stationary mounting, internal to the fixed stator. The advantage of such a drive is that there are no parts with high inertia rotating at high speed, which reduces the kinetic energy stored in the drive and hence improves both controllability and safety.

The arrangement simplifies both transfer of torque out of the drive and restraint of the flex spline. The actuators can be accessed without disassembling the drive. This enables the actuators to be replaced relatively easily compared with the case of an internal mounting arrangement. External mounting improves the electrical connectivity of the actuators while at the same time allowing space for drive electronics to be mounted locally. Airflow around the actuators is similarly enhanced, which increases heat dissipation. The output shaft can be made hollow to allow passage of cables through the drive.

According to another feature of the invention, the actuator is a linear lightweight polymer, electrostrictive actuator.

Electrostrictive actuators are a class of electroactive polymers that deform under the influence of a high voltage electric field. The deformation is characterized by a reduction in thickness and an increase in area. This effect has been harnessed to create lightweight diaphragm-based actuators capable of high bandwidth linear position control. A commercial implementation of the technology has been created by Artificial Muscle Inc.

Lightweight polymer, electrostrictive actuators are claimed to offer a power to weight ratio up to two orders of magnitude higher than that of electromagnetic devices. This in theory allows the stored kinetic energy to be significantly lower than that of a conventional electric motor and reduction gear drive, which increases inherent safety.

The displacement attainable with electrostrictive actuators is greater than with piezo electric actuators which obviates the requirement for mechanical stroke amplification.

Another advantage of using electrostrictive actuators is that analogue position control is possible. This means that while there are a finite number of actuators, the displaced position of each actuator is, in theory, infinitely adjustable. This enables the rotational position of the ellipse shape, and hence that of the output shaft, to be steplessly controlled. By contrast, linear actuation achieved using electromagnetic principles tends to be characterised by “on-off” behavior, which limits controllability.

Compared with shape memory alloy actuators, electrostrictive actuators offer significantly higher bandwidh, with actuation frequencies of up to 17 kHz reported in the literature (Kornbluh, R. et al., 1998).

According to another feature of the invention, the actuator comprises means for transfer force from the actuators to the flex spline. Each transfer means comprises a miniature transfer unit comprising a rolling element e.g. a ball. The use of e.g. a ball to transfer force from the actuators to the flex spline allows deviation in the point of force application to occur without introducing losses due to friction or viscoelastic effects. Further, torsional stiffness of the drive is maintained. In the present design, the flex spline is afforded translational freedom through the use of rolling contact with the actuator.

According to another feature of the invention, the flex spline comprises a groove arranged running around the central portion of the outer surface of the flex spline. The flex spline comprises two portions on the outer surface of the flex spline, flanking either side of the groove, equipped with gear teeth.

The use of external gear teeth on both outer portions of the flex spline applies a restraining torque to both ends of the flex spline. This simplifies the construction and manufacture of the drive as the two halves of the stator are functionally identical.

According to a further feature of the invention, the flex spline is tube shaped. The flex spline is tubular and not cup-shaped, which enables simpler manufacturing processes such as extrusion to be employed. Furthermore, assembly of the drive is simplified.

An object of the invention is to provide an alternative solution to the concentricity problem in a drive assembly of the kind defined above.

This object is obtained by the features in the appended claims.

According to an aspect of the invention, the wave generator bearing serves as an exclusive drive end bearing for supporting the rotor shaft in the motor housing at a front side of the rotor. The rotor shaft may then have only two bearings, where the wave generator bearing is a single bearing for both the strain wave gearing and the drive end of the rotor shaft. In other words, the invention is to use the wave generator elliptic bearing directly as a motor bearing. The overconstrained situation in the traditional harmonic drive train design with three bearings on the same axis is thereby eliminated, thus solving the concentricity problem discussed above.

Benefits of the invention compared to the overconstrained design are lower tolerance demands on the assembly, longer life of the harmonic drive due to reduced wear from overconstrained bearings and reduced gearbox friction and ripple.

In an embodiment of the invention, the rear bearing is a ball bearing, e.g. a groove ball bearing. Thereby, the rotor shaft will allow for the possible misalignment—typically up to 0.2 mm—introduced when mounting the strain wave gearing to the motor.

While the groove ball bearing may be a single row groove ball bearing, in another embodiment, the rear bearing is a spherical double-row groove ball bearing. Such a double row bearing may allow for smooth running under relative large axial misalignments.

While the strain wave gearing may conventionally be mounted to the drive end plate of the motor, in another embodiment of the invention, the circular spline may be designed to form the drive end plate of the motor housing. Thereby, the drive assembly may be simplified, resulting in reduced length, weight and cost.

To avoid axial play in the rotor shaft resulting from the absence of the conventional front end bearing of the rotor shaft, a spring may be provided for axially biasing the rotor shaft.

Specifically, the spring may be a compression spring located between a rearward face of the flex spline and a front face of the rotor shaft. The spring will thereby be concealed in the otherwise dead space within the cup-shaped flex spline.

The drive assembly may further have a sealing between the strain wave gearing and the motor to prevent ingress of lubricant from the gearing to the motor.

According to further aspects of the invention are defined an industrial robot provided with a drive assembly having any one of the above defined features, a robot boom provided with a drive assembly having any one of the above defined features, and a robot joint provided with a drive assembly having any one of the above defined features.

Other features and advantages of the invention may be apparent from the appended claims and the following detailed description of embodiments.

### BRIEF DESCRIPTION OF THE DRAWINGS

FIG. 1 is a harmonic motor according to the invention,

FIG. 2 is a radial cross section X-X through the harmonic motor in FIG. 1,

FIG. 3 is an axial cross section through the harmonic motor in FIG. 1,

FIG. 4 is a radial cross section Y-Y through the harmonic motor in FIG. 1,

FIG. 5 is a phased cyclic displacement of the actuators over a single rotation of the ellipse shape,

FIGS. 6a-6f are an operating principle of the harmonic drive gear reducer,

FIG. 7 is an integrated harmonic drive arrangement in which motor rotor and windings share a common housing and bearings with the gear reducer.

FIG. 8 is a harmonic motor comprising discrete linear actuators attached to a stationary hub for deforming a flex spline,

FIGS. 9a-9b are an electromagnetic harmonic motor using magnetic attraction,

FIG. 10 is an electromagnetic harmonic motor using magnetic repulsion

FIG. 11 is a view with parts broken away of a drive assembly according to the invention;

FIG. 12 is a diagrammatic sectional side view of a drive assembly according to the invention;

FIG. 13 is a cross-sectional view taken along line 3-3 of an assembly according to FIG. 12; and

FIG. 14 is a rearward side view of a robot wrist provided with a couple of drive assemblies according to the invention.

### DETAILED DESCRIPTION OF THE INVENTION

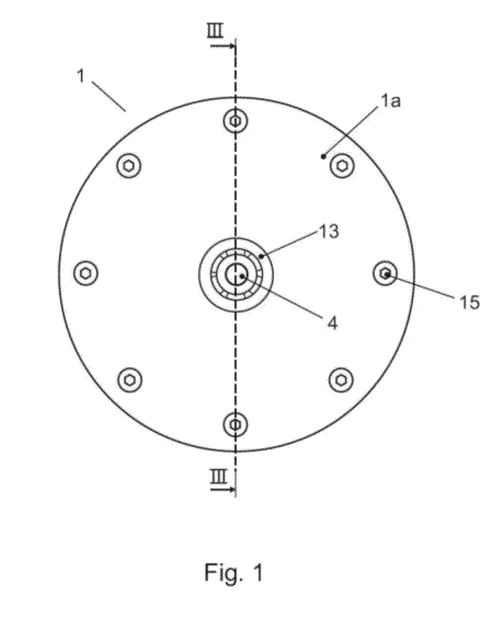

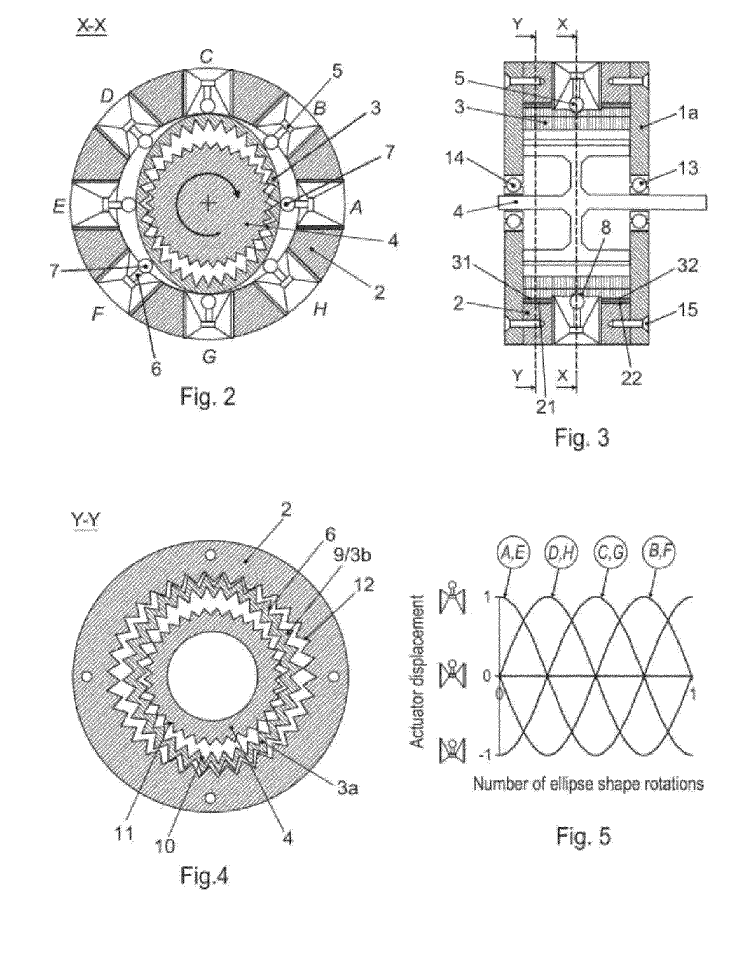

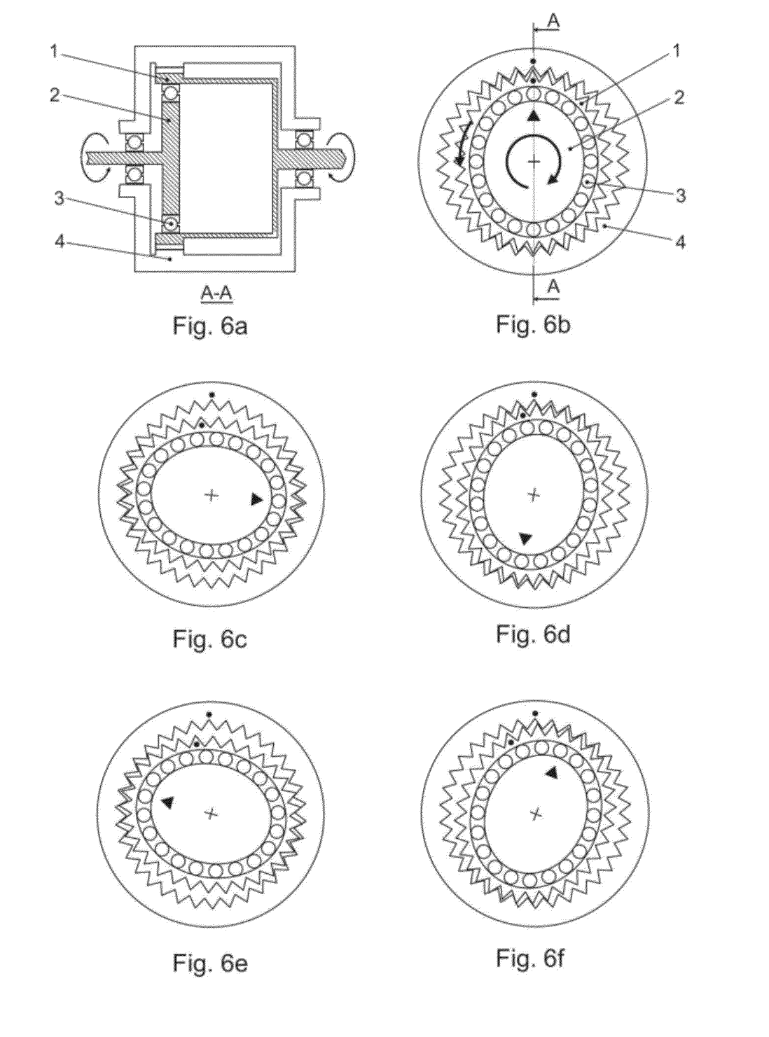

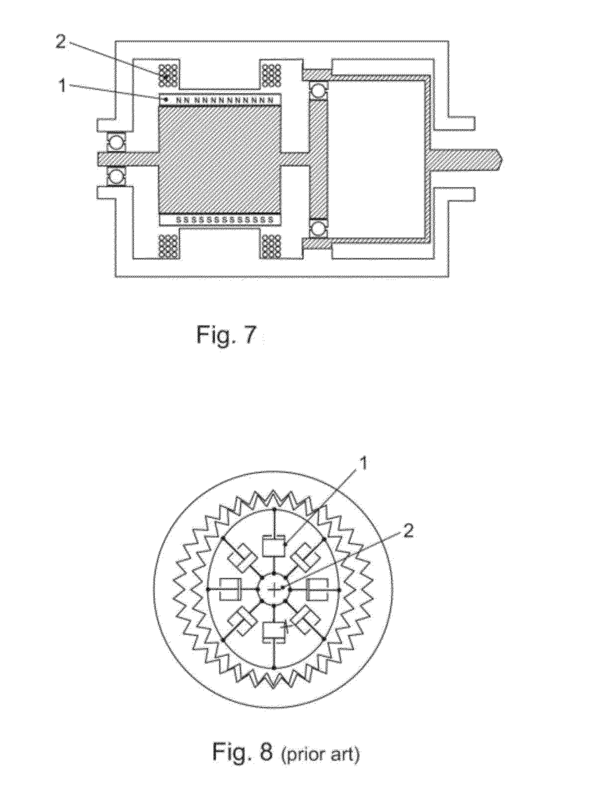

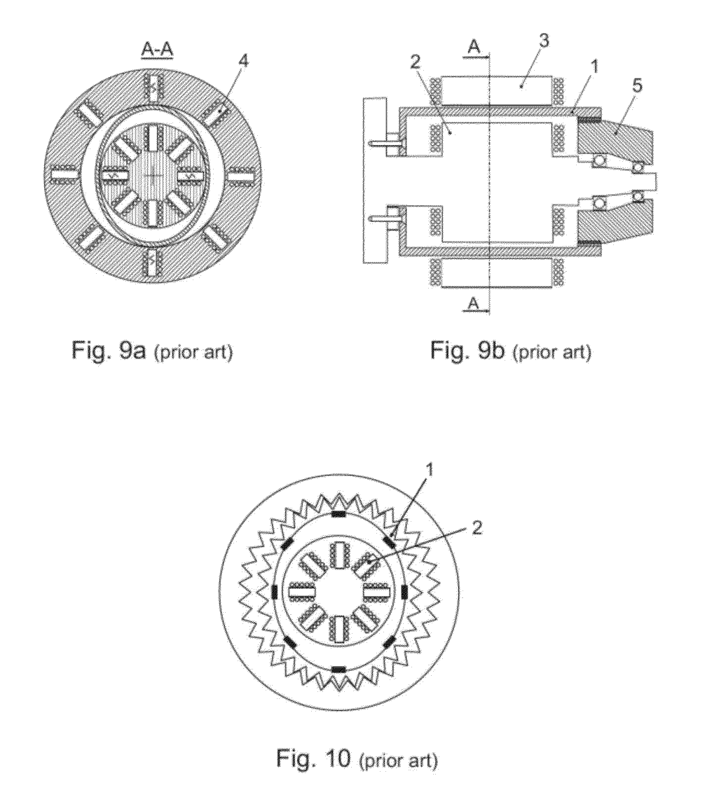

FIG. 1 is a harmonic motor 1 according to the present invention, where the housing 1a comprises fastening means 15 e.g. bolts. The motor comprises a fixed circular stator 2, a flex spline 3 and an output gear 4 (FIG. 2). The flex spline 3 is arranged coaxially within the stator 2. The output gear 4 is arranged coaxially within the flex spline 3 and supported by two bearings 13, 14 arranged in the housing 1a of the motor at a distance and on either side of the flex spline. Eight linear actuators 5 are mounted radially disposed on the internal surface 2a of the fixed stator 2. Each actuator comprises a means transferring force to the flex spline with an output shaft 6 connected to a ball 7. The ball is the rolling element within a miniature ball transfer unit.

The balls 7 locate in a v-shaped groove 8 arranged running around the central portion of the outer surface of the flex spline 3 (FIG. 3). The portions 31 and 32 on the outer surface 3b of the flex spline, flanking either side of the groove 8, are equipped with gear teeth 9 (FIG. 4). The teethed sections 31 and 32 of the flex spline, mesh with gears 12 comprised in the internally teethed sections 21 and 22 of the stator 2.

FIG. 5 illustrates the phased cyclical displacement of the actuators 5 as a function of the angular position of the ellipse. The traveling wave is generated by means of eight actuators, which apply force in a radial direction directly to the external surface 3b of the flex spline by way of the miniature ball transfer units.

The number of teeth in the teethed sections 21, 22 on the stator 2 equals that on the external surface 3b of the flex spline 3, although the diameter of the stator gear is slightly larger, being equal to the locus of the endpoints of the major axis of the rotating ellipse. In this way the flex spline 3 meshes at the two lobes of the ellipse shape and every tooth 31, 32 on the flex spline 3 always meshes with the same counterpart tooth 21, 22 on the stator 2 (FIG. 4). This arrangement prevents rotation of the flex spline 3 relative to the stator 2 while allowing the point of force application on the flex spline surface to translate, by way of the ball 7 transfer units, relative to the actuators 5. This occurs whenever the ellipse major or minor axes are not orthogonally aligned with a given actuator.

Gear teeth 10 on the inner surface 3a of the flex spline mesh with the gears 11 on the rigid circular output shaft 4 arranged coaxially within the flex spline. There are 2n fewer teeth on the output gear 4 than on the inner surface of the flex spline, where n is a positive integer. As the shape of the ellipse rotates, the output gear rotates in the same sense, but at a reduced speed. The reduction ratio (output speed/input speed) is given by the number of teeth on the flex spline divided by 2n.

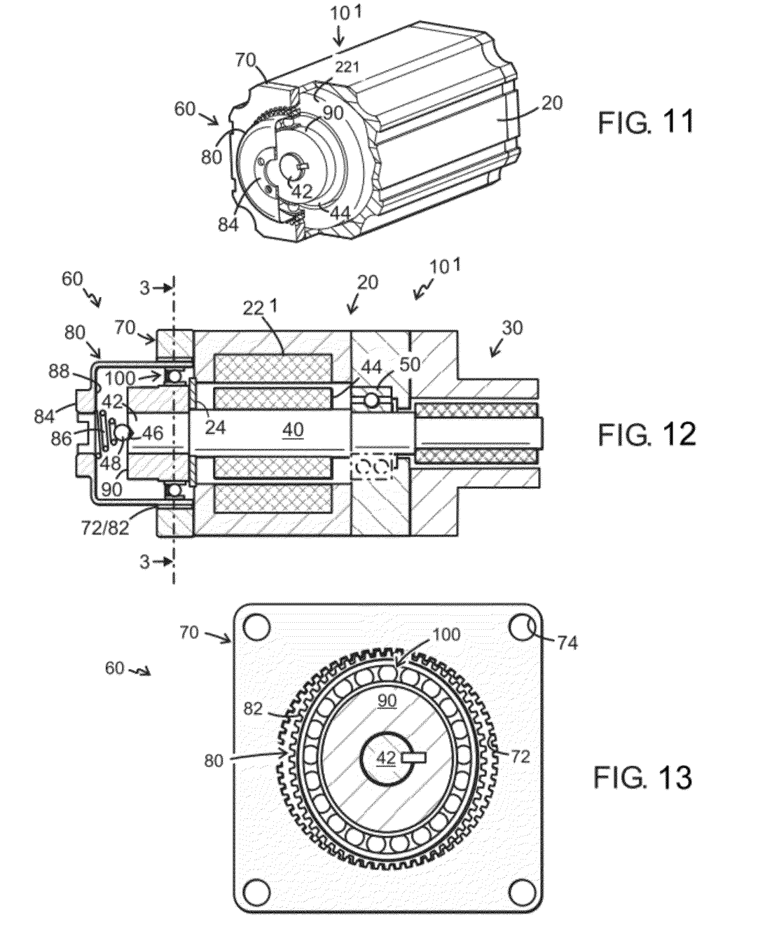

The drive assembly shown in FIG. 11 comprises a motor 101 and a strain wave gearing 60. In the example shown, the motor 101 is an electric motor, such as a servomotor of the type that can be used together with gearing 60, for example to actuate a pitch and/or roll mechanism in an industrial robot (not shown) connected to an output end 84 of gearing 60.

As apparent from FIGS. 11 and 12, the motor 101 has a rotor shaft 40 rotationally supported in a motor housing 20. In a well-known manner, a rotor 44 on the shaft 40 is electromagnetically energized by a stator 221 in the housing 20 to rotate shaft 40. As further indicated in FIG. 12, the motor 101 may also have a rear end resolver unit 30 for controlling motor operation.

Also in a well-known manner, the strain wave gearing 60 has a circular spline 70, a cup-shaped flex spline 80, a wave generator comprising an elliptical wave generator plug 90 connected to a drive end 42 of shaft 40, and a wave generator bearing 100. As can be understood from FIG. 13, flex spline 80 and wave generator bearing 100 are elastically deformed by plug 90 to an elliptical shape. The elliptical shape will rotate inside the circular spline 70 when the plug 90 is rotated by the rotor shaft drive end 42. External teeth 82 of the flex spline 80 mesh with internal teeth 72 of the circular spline 70 at opposite major axis ends of the elliptical shape. As a result, since the number, e.g. fifty-six, of external teeth 82 is smaller than the number, e.g. sixty, of internal teeth 72, in operation the flex spline 80 will rotate in an opposite direction to the elliptical shape with a ratio determined by the difference between the respective number of teeth 72 and 82, all in a well-known manner.

According to the invention, the wave generator bearing 100 serves as an exclusive drive end bearing. As shown in FIG. 12, the shaft 40 is accordingly supported only by a rear bearing 50 and the wave generator bearing 100 in the assembly.

The rear bearing 50 may be a single-row groove ball bearing, as indicated in full line in FIG. 12. The rear bearing 50 may, however, also be a spherical double-row groove ball bearing, as diagrammatically indicated in phantom in FIG. 12.

While the circular spline 70 may equally well have, for example, a conventional annular shape that is bolted to a motor front end plate, in the embodiments shown, the circular spline 70 is shaped to function also as the motor front end plate. The circular spline 70 is then secured to the motor housing 20 for example by bolts through bores 74 (FIG. 13) as a conventional motor end plate.

To eliminate axial play of the rotating parts in the assembly, the rotor shaft 40 is biased in an axial direction. In the example shown in FIG. 12, a compression spring comprising a conical coil spring 86 is located between a rear bottom face 88 of the cup-shaped flex spline 80 and a front face of the drive end 42 of rotor shaft 40. Both bearings 50 and 100 will thereby be independently subjected to forces that eliminate axial play. A ball 48 received in a groove 46 of drive end 42 may be provided to keep the spring 86 in place and to reduce friction between spring 86 and drive end 42.

To avoid leakage of grease from the strain wave gearing 60 into the motor housing and to other components such as a mechanical brake (not shown) engaging the rotor shaft 40, a sealing 24 such as a labyrinth sealing acting on the rotor shaft 40 may be provided between the gearing 60 and the motor 101, as diagrammatically indicated in FIG. 12.

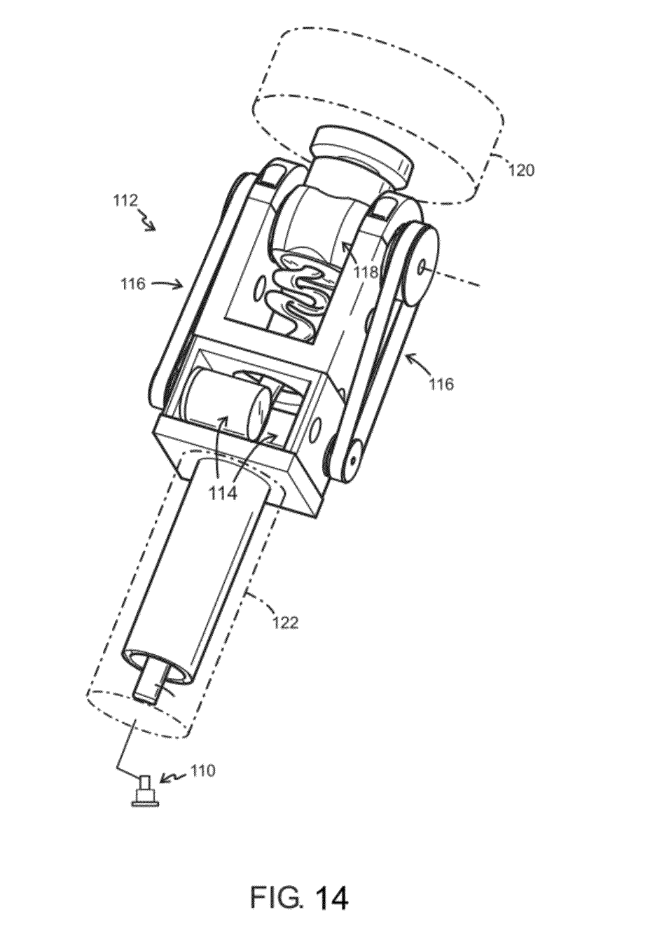

In the example shown in FIG. 14, a pair of drive assemblies 114 according to the invention are shown transversely mounted to a robot joint or wrist 112 having an end effector 120. The wrist 112 is connected to a boom 122 of a diagrammatically depicted industrial robot 110. Drive ends of drive assemblies 114 are connected to respective belt transmissions 116 that in turn are connected to a differential gear 118. In a well-known manner, the output of each drive assembly 114 may be independently controlled for controlling respective pitch and roll movements of the end effector 120 through the differential gear 118.

The foregoing detailed description is given primarily for clearness of understanding and no unnecessary limitations are to be understood therefrom. Modifications will become obvious to those skilled in the art upon reading this disclosure and may be made without departing from the spirit of the invention or the scope of the appended claims.

What is claimed is:

1. A drive assembly comprising:
a motor including:
a motor housing,
a rotor,
a rotor shaft, and
a rear bearing for supporting the rotor shaft in the motor housing at a rear side of the rotor; and
a strain wave gearing including:
a circular spline secured to the motor housing,
a flex spline engaging the circular spline,
a wave generator engaging the flex spline and secured to a drive end of the rotor shaft, and
a wave generator bearing between the circular spline and the wave generator;
wherein the wave generator bearing serves as an exclusive drive end bearing for supporting the rotor shaft in the motor housing at a front side of the rotor.

2. The drive assembly according to claim 1, wherein the rear bearing is a ball bearing.

3. The drive assembly according to claim 2, wherein the rear bearing is a spherical double-row ball bearing.

4. The drive assembly according to claim 1, wherein the circular spline forming a drive end plate of the motor housing.

5. The drive assembly according to claim 1, comprising a spring for axially biasing the rotor shaft to reduce play in said bearings.

6. The drive assembly according to claim 5, wherein the spring being a compression spring located between a rearward face of the flex spline and a front face of the rotor shaft.

7. The drive assembly according to claim 1, comprising a sealing between the gearing and the motor to prevent ingress of lubricant from the gearing to the motor.

8. The drive assembly according to claim 1, wherein the strain wave gearing is mounted to a drive end plate of the motor.

9. An industrial robot provided with a drive assembly according to claim 1.

10. A robot boom provided with a drive assembly according to claim 1.

11. A robot joint provided with a drive assembly according to claim 1.

12. A harmonic motor comprising a fixed and circular stator, an output shaft, a flex spline and a wave generator wherein the stator comprises internal gears, the flex spline is coaxially arranged within the stator and comprises both external and internal gears, the output shaft comprises external gears and is coaxially arranged within the flex spline, the wave generator comprises means for sequentially deforming the flex spline into an ellipse shape internally meshing the output shaft and externally meshing the stator, and the number of teeth on the stator equals the external teeth on the flex spline such that the flex spline meshes at two lobes of the ellipse shape and every tooth on the flex spline meshes with the same counterpart tooth on the stator.

13. A harmonic motor according to claim 11, wherein the deforming means comprises a plurality of actuators adapted to transfer forces from the actuators to the flex spline.

14. A harmonic motor according to claim 13, wherein the actuators are arranged internal in the stator.

15. A harmonic motor according to claim 14, wherein the actuator is a lightweight polymer, electrostrictive actuator.

16. A harmonic motor according to claim 13, wherein the deforming means comprises a miniature transfer unit with a rolling element.

17. A harmonic motor according to claim 16, wherein the rolling element is a ball.

18. A harmonic motor according to claim 12, wherein the flex spline is tube shaped.

19. A harmonic motor according to claim 18, wherein the flex spline comprises a groove arranged running around the central portion of the outer surface of the flex spline.

20. A harmonic motor according to a claim 19, wherein the flex spline comprises two portions and equipped with gear teeth on the outer surface, flanking either side of the groove.
